(19) United States
(12) Patent Application Publication
(10) Pub. No.: US 2003/0153657 A1
(43) Pub. Date: Aug. 14, 2003

(54) Polymer blends containing phosphates

(76) Inventors: Burkhard Reitze, Bergisch Gladbach (DE); Raimund Zimmermann, Langenfeld (DE); Wilfried Haese, Odenthal (DE); Thomas Eckel, Dormagen (DE)

Correspondence Address: BAYER POLYMERS LLC, 100 BAYER ROAD, PITTSBURGH, PA, 15205, US

(21) Appl. No.: 10/220,248

(22) PCT Filed: Feb. 20, 2001
(86) PCT No.: PCT/EP01/01872

(30) Foreign Application Priority Data
Mar. 3, 2000 (DE) 100 10 428.2

(51) Int. Cl. C08K 5/49; C08K 5/52

(52) U.S. Cl. 524/121; 524/140

(57) ABSTRACT

The present invention provides thermoplastic blends containing polycarbonate, mold-release agents with OH groups and mixtures of oligomer and monomer phosphorous compounds. The thermoplastic blends of the present invention find use in the manufacture of optical data carriers such as compact discs, video discs and other optical data carriers which can be written on and erased.

The application relates to new thermoplastic polymer mixtures containing polycarbonate, mould release agents with OH groups and mixtures of oligomeric and monomeric phosphorus compounds as well as the use of such polymer mixtures for producing optical data carriers such as for example compact discs, video discs and further singly or multiply writeable as well as deleteable optical data carriers, and also the optical data carriers that can be produced therefrom.

Polycarbonates are generally used on account of their special combination of properties such as transparency, heat resistance, dimensional stability and thermal stability, as materials for injection moulding or injection-compression moulding of optical data carriers. In order to improve the processability, which in general takes place at temperatures above 300° C., the polycarbonate contains additives such as mould release agents and stabilisers.

As mould release agents there are preferably used aliphatic fatty acid partial esters of polyhydric alcohols, such as for example partial esters of glycerol with long-chain fatty acids, in particular glycerol monostearate. The presence of free OH groups in the ester is obviously particularly advantageous for the mould-release effect, though these esters impair the thermal stability of the mixture with the result that it is necessary to add stabilisers. Fully esterified mould release agents on the other hand have a high stability, so that the addition of stabilisers would no longer appear necessary, according to EP-A 628 957, although the mould release action of such esters at low concentrations is significantly weaker than that of esters containing free OH groups. If larger amounts of fully esterified mould release agents are used, there is an increased danger of the formation of deposits in the mould, which means that the moulds and matrices have to be cleaned more often during processing, which is a disadvantage and can lead to a poorer sheet quality.

In order to stabilise mixtures containing mould release agents with OH groups, EP-A 205 192 discloses mixtures of trimethyl phosphate and/or triethyl phosphate in combination with phosphites. The stabilising effect of the phosphoric acid esters alone is however not sufficient, with the result that it is necessary to add phosphites, and furthermore these phosphoric acid esters are regarded as ecologically harmful.

JP-A 01 242 660 uses phosphoric acid for stabilisation purposes, although there is then the danger of corrosion of the storage layers on the optical data carriers under conditions involving high atmospheric moisture and elevated temperatures. The same problem exists in the mixtures of different phosphoric acids used in JP-A 04 041 551.

JP-A 62 207 358 proposes the use of special phosphoric acid esters, in which the structure of these phosphoric acid esters has been modified so that they simultaneously have a mould-release effect and the conventional mould release agents can thus be omitted. These phosphoric acid compounds are however difficult and costly to produce and have not proved effective.

JP-A 62 184 639 proposes, inter alia, the use of triphenyl phosphate as stabiliser, which however is inferior as regards its effect to trimethyl phosphate.

The object therefore existed of developing polymer mixtures that have a good mould-release action under manufacturing and processing conditions in the manufacture of products for optical applications, such as compact discs and digital versatile disks (DVDs), and are thermally stable and form only small amounts of deposits in the mould, so that the end result is an improved quality of the data storage media and the processability of the material in the injection moulding and injection-compression moulding processes is improved. This object is achieved by means of the polymer mixtures according to the invention, which contain at least one polycarbonate and at least one mould-release agent with at least one free OH group, as well as a special mixture of phosphorus compounds.

The present application accordingly provides thermoplastic polymer mixtures containing at least one polycarbonate and at least one mould release agent with at least one free OH group, as well as at least one monophosphorus compound and at least one oligomeric phosphorus compound as a special mixture of phosphorus compounds. The invention also provides for the use of such polymer mixtures to produce optical data carriers, such as for example compact discs, video discs and further singly or multiply writeable as well as deleteable optical data carriers, as well as the optical data carriers themselves that can be produced from these polymer mixtures.

Thermoplastic polymer mixtures within the context of the present invention contain predominantly aromatic polycarbonates. Polycarbonates are understood to include both homopolycarbonates as well as copolycarbonates; the polycarbonates may, in a manner known per se, be linear or branched.

These polycarbonates are produced in a manner known per se from diphenols, carbonic acid derivatives, optionally chain terminators, and optionally branching agents.

Details concerning the production of polycarbonates can be found in many patent specifications over the last 40 years or so. By way of example reference will be made here only to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertne', BAYER AG, “Polycarbonates” in Encyclopedia of Polymer Science and Engineering, Volume 11, Second Edition, 1988, pp. 648-718 and finally to Dres. U. Grigo, K. Kirchner and P. R. Müller “Polycarbonates” in Becker/Braun, Kunststoff-Handbuch, Vol. 3/1, Polycarbonates, Polyacetates, Polyesters, Cellulose Esters, Carl Hanser Verlag Munich, Vienna 1992, pp. 117-299.

For the production of the polycarbonates suitable diphenols are for example hydroquinone, resorcinol, dihydroxydiphenyls, bis-(hydroxyphenyl)-alkanes, bis(hydroxyphenyl)-cycloalkanes, bis(hydroxyphenyl)-sulfides, bis(hydroxyphenyl)-ethers, bis(hydroxyphenyl)-ketones, bis(hydroxyphenyl)-sulfones, bis(hydroxyphenyl)-sulfoxides, α,α′-bis(hydroxyphenyl)-diisopropylbenzenes, as well as their nuclear-alkylated and nuclear-halogenated compounds.

Preferred diphenols are 4,4′-dihydroxyphenyl, 2,2-bis-(4-hydroxyphenyl)-propane, 2,4-bis-(4-hydroxyphenyl)-2-methylbutane, 1,1-bis-(4-hydroxyphenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 1,1-bis-(3,5-dimethyl-4-hydroxyphenyl)-p-diisopropylbenzene, 2,2-bis-(3,5-dichloro-4-hydroxyphenyl)-propane, 2,2-bis-(3,5-dibromo-4-hydroxyphenyl)-propane, 1,1-bis-(4-hydroxyphenyl)-3,3,5-trimethylcyclohexane and 4,4′-(m-phenylenediisopropylidene)diphenol.

Particularly preferred diphenols are 2,2-bis-(4-hydroxyphenyl)-propane (BPA), 2,2-bis-(3,5-dimethyl-4-hydroxyphenyl)-propane, 2,2-bis-(3,5-dichloro-4-hydroxyphenyl)-propane, 2,2-bis-(3,5-dibromo-4-hydroxyphenyl)-propane, 4,4′-(m-phenylenediisopropylidene) bisphenol (CAS-No. 13595-25-0) (BPM), 1,1-bis-(4-hydroxyphenyl)-cyclohexane and 1,1-bis-(4-hydroxyphenyl)-3,3,5-trimethylcyclohexane (TMC).

These and further suitable diphenols are described for example is U.S. Pat. Nos. 3,028,635, 2,999,835, 3,148,172, 2,991,273, 3,271,367, 4,982,014 and 2,999,846, in German laid open applications 1 570 703, 2 063 050, 2 036 052, 2 211 956 and 3 832 396, in French patent specification 1 561 518, in the monograph “H. Schnell, Chemistry and Physics of Polycarbonates, Interscience Publishers, New York 1964”, as well as in Japanese laid open specifications 62039/1986, 62040/1986 and 105550/1986.

In the case of homopolycarbonates only one diphenol is used, while in the case of copolycarbonates several diphenols are used.

Preferably polymer mixtures are used that contain at least one polycarbonate with diol building blocks from BPA and/or trimethylcyclohexyl bisphenol (TMC), preferably selected from the group comprising homopolymers of BPA, copolymers of BPA with TMC or copolymers containing 5 to 60 wt. % of TMC.

Suitable carbonic acid derivatives are for example phosgene or diphenyl carbonate.

Suitable chain terminators are monophenols as well as monocarboxylic acids. Suitable monophenols are phenol itself, alkylphenols such as cresols, p-tert.-butylphenol, p-n-octylphenol, p-iso-octylphenol, p-n-nonylphenol and p-iso-nonylphenol, p-cumylphenol, halogenated phenols such as p-chlorophenol, 2,4-dichlorophenol, p-bromophenol, amyl phenol and 2,4,6-tribromophenol as well as their mixtures.

Preferred chain terminators are the phenols of the formula (I)

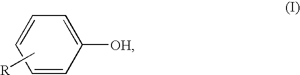

wherein R denotes hydrogen, tert.-butyl or a branched or unbranched C₈- and/or C₉-alkyl radical. P-cumylphenol may however also preferably be used.

The amount of chain terminators to be used, preferably in the phase interface process, is 0.1 mole % to 5 mole %, referred to moles of diphenols used in each case. The chain terminators may be added before, during or after the phosgenation.

Suitable branching agents are the trifunctional or higher functional compounds known in polycarbonate chemistry, in particular those with three or more than three phenolic OH groups.

Suitable branching agents are for example phloroglucine, 4,6-dimethyl-2,4,6-tri-(4-hydroxyphenyl)-heptene-2,4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis-[4,4-bis-(4-hydroxyphenyl)-cyclohexyl]-propane, 2,4-bis-(4-hydroxyphenylisopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenylisopropyl)-phenyl)-orthoterephthalic acid esters, tetra-(4-hydroxyphenyl)-methane, tetra-(4-(4-hydroxyphenylisopropyl)-phenoxy)-methane and 1,4-bis-(4′,4″-dihydroxy-triphenyl)-methyl)-benzene, as well as 2,4-dihydroxybenzoic acid, trimesic acid, cyanuric chloride and, for some applications, even preferably 3,3-bis-(3-methyl-4-hydroxyphenyl)-2-oxo-2,3-dihydroindole.

The amount of branching agents that may optionally be used is 0.01 mole % to 2 mole %, referred again to moles of diphenols used in each case.

In the phase interface process the branching agents may be added to the aqueous alkaline phase either together with the diphenols and the chain terminators, or may be added dissolved in an organic solvent. In the case of the transesterification process the branching agents may be added together with the diphenols.

All these procedures for producing the thermoplastic polycarbonates are known to the person skilled in the art.

The compounds used as mould release agents are preferably esters of polyhydric alcohols with long-chain carboxylic acids that have not been completely esterified. Esters of saturated monobasic fatty acids containing 16 to 22 carbon atoms with glycerol, trimethylolpropane, pentaerythritol or similar polyhydric alcohols are preferably used. Glycerol monostearate and glycerol monopalmitate are particularly preferred.

Such saturated monofunctional fatty acid esters of glycerol are used alone or as mixtures comprising two or more components. The saturated monoesters of glycerol are normally prepared by the esterification of hydrogenated animal or vegetable oils with glycerol. Although the reaction product may also contain esters other than the glycerol esters, it is used as mould release agent according to the invention. For example the mixture may contain small or larger amounts of diglycerides and triglycerides.

The optimum amount of mould release agent is determined on the one hand by the need for a sufficient mould-release effect, and on the other hand by the formation of deposits on the mould. The concentrations of mould release agent that are normally used are between 50 to 1000 ppm, more preferably between 100 and 500 ppm.

The special mixtures of phosphorus compounds according to the invention contain a monophosphorus compound C.1 and a phosphorus compound C.2.

Component C.1 is a phosphorus compound according to formula (II).

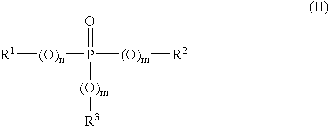

In the formula R¹, R² and R³ independently of one another denote C₁-C₈-alkyl, preferably C₁-C₄-alkyl, C₆-C₂₀-aryl, preferably phenyl or naphthyl, and/or C₇-C₁₂-aralkyl, preferably phenyl-C₁-C₄-alkyl, and m is 0 or 1 and n is 0 or 1.

The phosphorus compounds according to component C.1 used according to the invention are generally known (see for example Ullmanns Enzyklopädie der technischen Chemie, Vol, 18, p. 301 ff, 1979; Houben-Weyl, Methoden der Organischen Chemie, Vol. 12/1, p. 43; Beilstein, Vol. 6, p. 177). Preferred substituents R¹ to R³ are, independently of one another, methyl, butyl, octyl, phenyl, cresyl, cumyl and naphthyl. Particularly preferred are methyl, ethyl, butyl, and phenyl optionally substituted by methyl or ethyl.

Phosphorus compounds C.1 of the formula (II) are for example and preferably tributyl phosphate, triphenyl phosphate, tricresyl phosphate, diphenylcresyl phosphate, diphenyloctyl phosphate, diphenyl-2-ethylcresyl phosphate, tri-(isopropylphenyl)-phosphate, methylphosphonic acid dimethyl esters, methylphosphonic acid diphenyl esters, phenylphosphonic acid diethyl esters, triphenylphosphine oxide and tricresylphosphine oxide.

Component C.2 is a phosphorus compound of the formula (III).

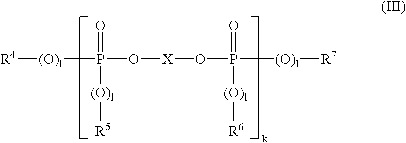

In the formula R⁴, R⁵, R⁶, R⁷ independently of one another denote C₁-C₈-alkyl, preferably C₁-C₄-alkyl, C₅-C₆-cycloalkyl, C₆-C₁₀-aryl and/or C₇-C₁₂-aralkyl, preferably phenyl, naphthyl or benzyl. The aromatic groups R⁴, R⁵, R⁶ and R⁷ may in turn be substituted by alkyl groups. Particularly preferred aryl radicals are cresyl, phenyl, xylenyl, propylphenyl or butylphenyl.

X in the formula (III) denotes a mononuclear or polynuclear aromatic radical with 6 to 30 C atoms.

This aromatic radical is derived from the aforedescribed diphenols such as, by way of example and preferably, BPA, resorcinol or hydroquinone.

In the formula (III) “l” may independently of one another be 0 or 1, and preferably “l” is equal to 1; “k” has a value from 1 to 5, preferably 1 or 2.

The oligomeric phosphorus compounds of the formula (III) are preferably reaction products of the reaction of mixtures of phenol with hydroquninone or BPA or in particular resorcinol with phosphorus oxytrichloride or reaction products of the esterification of phosphoric acid triphenyl esters with hydroquinone or BPA or especially resorcinol.

Mixtures of different phosphates may also be used as component C.2 according to the invention. In this case “k” has an average value of 1 to 5, preferably 1 or 2.

The polymer mixtures according to the invention contain a mixture of C.1 and C.2. The mixture generally comprises 10 to 90 wt. % of the component C.1 and 90 to 10 wt. % of the component C.2 (in each case referred to the total amount of phosphorus compounds). Particularly favourable properties are obtained with mixtures comprising 12 to 50 wt. %, in particular 14 to 40 wt. % and most particularly preferably 15 to 40 wt. % of component C.1, and 88 to 50 wt. %, in particular 86 to 60 wt. % and most particularly preferably 85 to 60 wt. % of component C.2 (in each case referred to the total amount of phosphorus compounds).

The polymer mixtures according to the invention preferably contain 0.01 to 0.1 wt. % of mould release agents and 0.002-0.1 wt. % of the mixture of phosphorus compounds according to the invention. Particularly preferably they contain 0.01-0.05 wt. % of mould release agents and 0.005 to 0.02 wt. % of the mixture of phosphorus compounds according to the invention.

The addition of the mould release agents and of the oligomeric phosphorus compounds to the thermoplastic polymer mixtures takes place for example and preferably by metering them in after the production and during the processing of the polycarbonates, for example by addition to the polycarbonate polymer solution, or to a melt of the thermoplastic polymer mixtures. It is also possible to meter in the components independently of one another in different working steps, for example to meter in one of the components during the processing of the polymer solution and the other component(s) into the melt, as long as it is ensured that all components are included in the production of the end products (moulded articles).

The thermoplastic polymer mixtures according to the invention may furthermore contain conventional additives for polycarbonates in known amounts, such as for example and preferably stabilisers against UV radiation, flame retardants, pigments, fillers, foaming agents, optical brighteners and antistatics. In optical applications such components are preferably used that do not adversely affect the transparency of the material.

The polymer mixtures according to the invention are used in the manner known for polycarbonates, for producing moulded articles, preferably optical media, in particular written or singly or multiply writeable optical media, preferably optical data carriers, particularly preferably compact discs and DVDs. In this connection the writeable layers consist in particular of pigments or metallic layers, which in turn utilise the conversion from the amorphous to the crystalline state as recording principle or possess magnetic properties.

The optical media are preferably produced from the ready-to-use polymer mixtures according to the invention, which may for example be in the form of granules. The optical media may however also be produced by incorporating the components into pure or commercially available polycarbonates and/or into the additives conventionally used in the production of moulded articles from polycarbonates.

The invention accordingly furthermore provides moulded articles, such as in particular optical data carriers, preferably compact discs and DVDs, that can be obtained from the thermoplastic polymer mixtures according to the invention.

The thermoplastic polymer mixtures according to the invention have the advantage that they exhibit a better thermal stability in the production of moulded articles, and the resultant end products (moulded articles) can easily be removed from the production moulds and do not leave behind any impurities on the moulds.

The following examples serve to illustrate the invention. The invention is however not restricted to these examples.

### EXAMPLES

The following mixtures were prepared:

### Examples 1 to 6

Corresponding to the following Table, x parts by weight of polycarbonate granules of BPA-PC with tert.-butylphenol terminal groups and a mean solution viscosity of 1.195 (measured in methylene chloride at 25° C. and a concentration of 0.5 g in 100 ml of methylene chloride) are thoroughly mixed with y parts by weight of glycerol monostearate and z parts by weight of phosphorus compound in a closed vessel. The mixture is then compounded in a Werner & Pfleiderer ZSK 52 two-screw kneader at a temperature of ca. 240° C.

TABLE 1

| | Polycar- | Glycerol | Oligo- | Triphenyl | Trioctyl |
|---|---|---|---|---|---|
| | bonate | Monostearate | phosphate | Phosphate | Phosphate |
| Example | 99.95 | 0.04 | 0.01 | | |
| Comparison Example 1 | 99.95 | 0.04 | | 0.01 | |
| Comparison Example 2 | 99.95 | 0.04 | | | 0.01 |
| Comparison Example 3 | 99.96 | 0.04 | | | |
| (without stabiliser) | | | | | |

The product Loxiol EP 129 from Henkel KgaA is used as glycerol monostearate. The product ADK Stab PFR from Asahi Denka/Tokyo is used as oligophosphate. Trioctyl phosphate and triphenyl phosphate are obtained from Bayer AG Leverkusen.

CD blanks are then produced from the aforedescribed materials on a CD injection moulding machine of the Netstal Discjet 600 type in order to measure the product stability of the CDs. The CDs have a thickness of 1.2 mm and an external diameter of 120 mm. The product stability is checked under different machine conditions, hereinafter identified as settings 1 to 4:

Setting 1:

Cylinder temperatures (feed/compression/cylinder head/nozzle) 315/320/320/320° C.; maximum injection rate: 130 mm/sec; mould (initial temperature): 55° C.; cycle time: 4.6 secs.

Setting 2:

Cylinder temperatures (feed/compression/cylinder head/nozzle) 315/340/350/350° C.; maximum injection rate: 110 mm/sec; mould (initial temperature): 55° C.; cycle time: 4.9 secs.

Setting 3:

Cylinder temperatures (feed/compression/cylinder head/nozzle) 315/360/380/380° C.; maximum injection rate: 100 mm/sec; mould (initial temperature): 55° C.; cycle time: 5.5 secs.

Setting 4:

Corresponding to setting 2, although the cycle is interrupted by a 5-minute machine stop. The fifth disk in each case is taken, after restarting the injection moulding machine, to carry out the following measurements.

The residual content of glycerol monostearate and the content of phenolic OH groups in the CD blanks is then measured. The following results are obtained:

TABLE 2
(GMS concentrations in ppm in the CD after
production under different conditions)

| | Setting 1 | Setting 2 | Setting 3 | Setting 4 |
|---|---|---|---|---|
| Example 1 | 395 | 350 | 295 | 225 |
| Comparison Example 1 | 340 | 295 | 255 | 195 |
| Comparison Example 2 | 305 | 290 | 260 | 185 |
| Comparison Example 3 | 290 | 285 | 220 | 105 |

The concentration of phenolic OH in the CD after production under different conditions is also measured.

TABLE 3
(Concentrations of phenolic OH in ppm in the CD after
production under different conditions)

| | Setting 1 | Setting 2 | Setting 3 | Setting 4 |
|---|---|---|---|---|
| Example 1 | 110 | 120 | 120 | 130 |
| Comparison Example 1 | 110 | 125 | 135 | 150 |
| Comparison Example 2 | 120 | 120 | 140 | 150 |
| Comparison Example 3 | 120 | 125 | 130 | 165 |

Detailed description of the measurement method:

Glycerol Monostearate

The glycerol monostearate is separated by gas chromatography on a capillary column and detected with a flame ionisation detector. The evaluation is performed according to the internal standard method. The determination limit is ca. 10 ppm.

Phenolic OH

The polycarbonate is dissolved in dichloromethane and titanium (IV) chloride is added, with the formation of an orange-red complex whose extinction is photometrically measured at 546 nm. The calibration is carried out with BPA as external standard. The determination limit is ca. 20 ppm OH.

The formation of deposits in the mould is also investigated. For this purpose 1000 partially filled CD blanks are in each case produced on a Netstal Discjet 600 CD injection moulding machine with a Axxicon-CD tool. The ca. 80% partial filling of the CDs is achieved by reducing the metering path and suitably adapting the holding pressure. The cylinder temperatures in the feed zone are 300° C., in the compression zone 310° C., while in the cylinder head and in the nozzle the temperature is 330° C. The cycle time is ca. 5.5 seconds. After the 1000^{th} shot the surface of the matrix and mirror is visually inspected for deposit formation in the external region, i.e. the region that does not come into contact with the polycarbonate melt. The following results are obtained:

TABLE 4

| | Deposit Formation |
|---|---|
| Example 1 | slight |
| Comparison Example 1 | average |
| Comparison Example 2 | average |
| Comparison Example 3 | relatively marked |

1. Thermoplastic polymer mixtures containing at least one polycarbonate and at least one mould release agent having at least one free OH group, as well as at least one monophosphorus compound and at least one oligomeric phosphorus compound.

2. Polymer mixtures according to claim 1, containing as monophosphoric compound a compound of the formula (II) 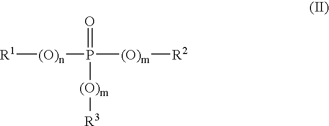
wherein in, the formula R¹, R² and R³ independently of one another denote C₁-C₈-alkyl, C₆-C₂₀-aryl and/or C₇-C₁₂-aralkyl and m denotes 0 or 1 and n denotes 0 or 1;
and as oligomeric phosphorus compound, a compound of the formula (III) 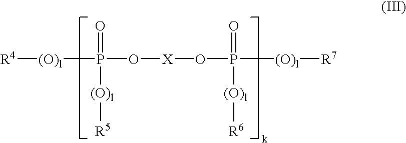
wherein in the formula R⁴, R⁵, R⁶, R⁷ independently of one another denote C₁-C₈-alkyl, C₅-C₆-cycloalkyl, C₆-C₁₀-aryl and/or C₇-C₁₂-aralkyl, and k is 1 to 5.

3. Polymer mixtures according to claim 1, containing at least one compound from the group comprising tributyl phosphate, triphenyl phosphate, tricresyl phosphate, diphenylcresyl phosphate, diphenyloctyl phosphate, diphenyl-2-ethylcresyl phosphate, tri-(isopropylphenyl)-phosphate, methylphosphonic acid dimethyl ester, methylophosphonic acid diphenyl ester, phenylphosphonic acid diethyl ester, triphenylphosphine oxide and tricresylphosphine oxide, and at least one oligomeric phosphorus compound, wherein the oligomeric phosphorus compound is a reaction product of the reaction of mixtures of phenol with resorcinol, hydroquinone or BPA with phosphorus oxytrichloride or of the esterification of phosphoric acid triphenyl ester with resorcinol, hydroquinone or BPA.

4. Polymer mixtures according to claim 1, containing a mixture of monophosphorus/phosphorus compounds, in which the mixture consists of 10 to 90 wt. % of monophosphorus compound of the formula (II) and 90 to 10 wt. % of the phosphorus compound of the formula (III), in each case referred to the total amount of phosphorus compounds.

5. Polymer mixtures according to claim 1, containing as mould release agent esters of polyhydric alcohols with long-chain carboxylic acids that are not completely esterified.

6. Polymer mixtures according to claim 1, containing as mould release agents the esters of saturated monobasic fatty acids containing 16 to 22 carbon atoms with glycerol, trimethylolpropane, pentaerythritol or similar polyhydric alcohols.

7. Polymer mixtures according to claim 1, containing 0.01 to 0.1 wt. % of mould release agent and 0.002-0.1 wt. % of the mixture of phosphorus compounds according to the invention.

8. Process for producing moulded articles, characterised in that polymer mixtures according to one of the preceding claims are used.

9. Moulded articles produced from thermoplastic polymer mixtures containing at least one polycarbonate and at least one mould release agent with at least one free OH group as well as a special mixture of phosphorus compounds.

10. Optical data carriers produced from thermoplastic polymer mixtures containing at least one polycarbonate and at least one mould release agent with at least one free OH group, as well as a special mixture of phosphorus compounds.

11. Mixture containing at least 10 to 90 wt. % of a compound of the formula (II) 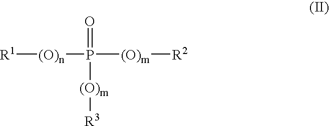
wherein in the formula R¹, R² and R³ independently of one another denote C₁-C₈-alkyl, C₆-C₂₀-aryl and/or C₇-C₁₂-aralkyl
and m denotes 0 or 1 and n denotes 0 or 1;
and at least 90 to 10 wt. % of a compound of the formula (III) 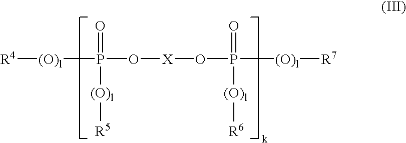
wherein in the formula R⁴, R⁵, R⁶, R⁷ independently of one another denote C₁-C₈-alkyl, C₅-C₆-cycloalkyl, C₆-C₁₀-aryl and/or C₇-C₁₂-aralkyl, and k is 1 to 5.

12. Process for producing moulded articles, characterised in that a mixture as defined in claim 11 is used.

13. Use of the mixture as defined in claim 11 for producing thermoplastic polymers and moulded articles that can be produced therefrom.

14. Use of the polymer mixtures as defined in the preceding claims for producing moulded articles.
